(19) United States
(12) Patent Application Publication
(10) Pub. No.: US 2018/0100737 A1
(43) Pub. Date: Apr. 12, 2018

(54) COMPUTER-READABLE RECORDING MEDIUM AND ROAD SURFACE CONDITION DETECTION DEVICE

(71) Applicant: FUJITSU LIMITED, Kawasaki-shi (JP)

(72) Inventor: Kosei Takano, Fujimino (JP)

(73) Assignee: FUJITSU LIMITED, Kawasaki-shi (JP)

(21) Appl. No.: 15/724,753

(22) Filed: Oct. 4, 2017

(30) Foreign Application Priority Data
Oct. 6, 2016 (JP) 2016-198537

(51) Int. Cl. G01B 21/30; G01N 21/88

(52) U.S. Cl. CPC G01B 21/30; G01N 2201/12; G01N 21/8851

(57) ABSTRACT

A road surface condition detection program causes a computer to execute a process of acquiring first degree of degradation for each position of a road and specifying a degradation position in which the first degree of degradation indicates a degradation state lower than a predetermined value. Furthermore, the road surface condition detection program causes a computer to execute a process of increasing, when acquiring second degree of degradation for each position of the road by using a method different from a method used for the first degree of degradation, regarding the specified degradation position, a measurement sensitivity used at the time of acquiring the second degree of degradation.

### CROSS-REFERENCE TO RELATED APPLICATION

This application is based upon and claims the benefit of priority of the prior Japanese Patent Application No. 2016-198537, filed on Oct. 6, 2016, the entire contents of which are incorporated herein by reference.

### FIELD

The embodiments discussed herein are related to a road surface condition detection device.

### BACKGROUND

When a road surface condition of a road is checked, there is a technology for detecting a degradation of a pavement by driving a vehicle on a road with a sensor that detects vibrations of a vehicle, by detecting irregularities of the road surface, and by determining that, regarding a location in which it is detected that a value of the sensor is equal to or greater than a fixed value, the pavement of the road is degraded. An example of the sensor that detects this type of vibrations includes, for example, an acceleration sensor.

Patent Document 1: Japanese Laid-open Patent Publication No. 2015-75934

With the technology described above, by increasing a detection sensitivity of a measurement value of the sensor, it is possible to detect further minute irregularities of the road surface; however, erroneous detection of the irregularities becomes more frequent. In contrast, in the technology described above, if the detection sensitivity of the measurement value of the sensor is too low, there may be a case in which irregularities of the road surface may not be detected until degradation progresses.

### SUMMARY

According to an aspect of an embodiment, a non-transitory computer-readable recording medium having stored therein a road surface condition detection program causes a computer to execute a process of acquiring first degree of degradation for each position of a road and specifying a degradation position in which the first degree of degradation indicates a degradation state lower than a predetermined value. Furthermore, the road surface condition detection program causes a computer to execute a process of increasing, when acquiring second degree of degradation for each position of the road by using a method different from a method used for the first degree of degradation, regarding the specified degradation position, a measurement sensitivity used at the time of acquiring the second degree of degradation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a detection result display screen of a road surface condition in a related technology;

FIG. 2 is a diagram illustrating another example of a detection result display screen of the road surface condition in a related technology;

FIG. 3 is a diagram illustrating an example of a detection result display screen of a road surface condition according to a first embodiment;

FIG. 4 is a diagram illustrating an example of a functional block of a road surface condition detection device according to the first embodiment;

FIG. 5 is a diagram illustrating an example of a reference value DB according to the first embodiment;

FIG. 6 is a diagram illustrating an example of a crack DB according to the first embodiment;

FIG. 7 is a diagram illustrating an example of an irregularity DB according to the first embodiment;

FIG. 8 is a diagram illustrating an example of a determination result DB according to the first embodiment;

FIG. 9 is a flowchart illustrating an example of a road surface condition detection process;

FIG. 10 is a diagram illustrating an example of a detection result display screen of a road surface condition according to a second embodiment;

FIG. 11 is a diagram illustrating an example of a reference value DB according to a third embodiment;

FIG. 12 is a diagram illustrating an example of a determination result DB according to the third embodiment; and

FIG. 13 is a diagram illustrating an example of a hardware configuration of a road surface condition detection device.

### DESCRIPTION OF EMBODIMENTS

Preferred embodiments of the present invention will be explained with reference to accompanying drawings. Furthermore, the present invention is not limited to the embodiments. Furthermore, the embodiments described below may also be appropriately used in combination as long as processes do not conflict with each other.

### [a] First Embodiment

As the criterion of a degradation of a road surface, for example, flatness, a crack rate, and rut amount of the road surface are known. In the following, a method of detecting the degradation of a road surface by using both the crack rate and the flatness of the road surface will be described. Furthermore, the crack rate in each section is specified by analyzing, for example, a captured image of the road surface in each section by using a known image analysis technology, or the like. Furthermore, the flatness of the road surface is detected by measuring, by using, for example, a vehicle having mounted thereon an acceleration sensor, a magnitude of a change in acceleration generated in the longitudinal direction in accordance with irregularities of the road surface when the vehicle is moving.

Example of Output Results

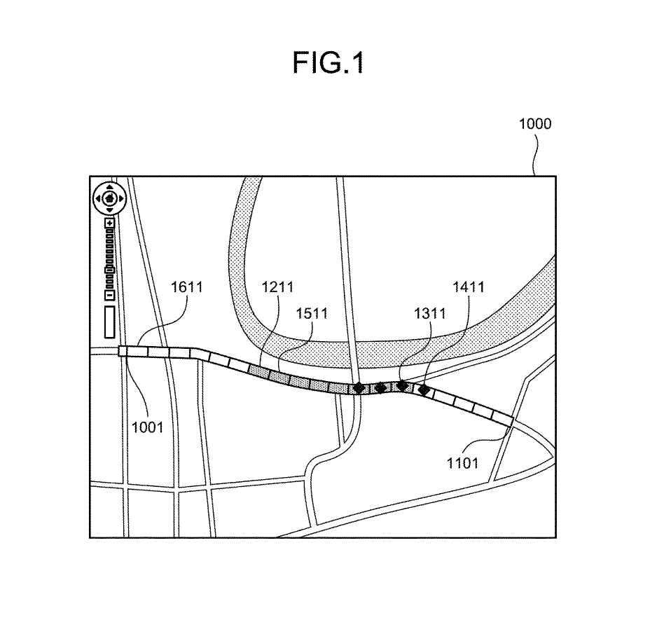

First, output results obtained by a road surface condition detection program according to the embodiment will be described with reference to FIGS. 1 to 3 by comparing the output results with those in a related technology. FIG. 1 is a diagram illustrating an example of a detection result display screen of a road surface condition in a related technology. FIG. 1 illustrates an example of a screen 1000 that outputs the detection result of the road surface condition of a targeted road from a starting position 1001 to an end position 1101.

In FIG. 1, the road from the starting position 1001 to the end position 1101 is divided into sections at intervals of 100 m. The frames between the starting position 1001 and the end position 1101 illustrated in FIG. 1 indicate the divided sections at intervals of 100 m. A user of the program refers to a displayed output result and specifies a section in which a restoration of the road surface is preferable.

Furthermore, in FIG. 1, the frames with a pattern from a section 1211 to a section 1311 indicate the sections that are determined as cracked, whereas white frames other than these patterned frames indicate the sections that are not determined as cracked. Furthermore, in a description below, for example, it is assumed that, if a specified crack rate is equal to or greater than a predetermined threshold, a subject section is determined as cracked and it is assumed that, if a crack rate is less than the predetermined threshold even if a crack is detected, the subject section is not determined as cracked.

For example, in the section determined as cracked, if a restoration is delayed, it is known that there is a high possibility that damage of the road surface deteriorates rapidly. Furthermore, repair cost of the road surface drastically increases in accordance with deterioration of the damage of the road surface. Thus, in order to reduce the repair cost of the road surface, in the section determined as cracked, it is preferable to give an immediate restoration before the damage of the road surface deteriorates even if irregularities of the road surface are small and are not detected as the degradation of the road surface with a low measurement sensitivity.

In contrast, in the sections that are not determined as cracked, there is a low possibility that the damage of the road surface deteriorates rapidly even without immediate restoration. Thus, regarding the sections that are not determined as cracked, in order to reduce the repair cost, it is conceivable that a restoration is performed after irregularities of the road surface is increased.

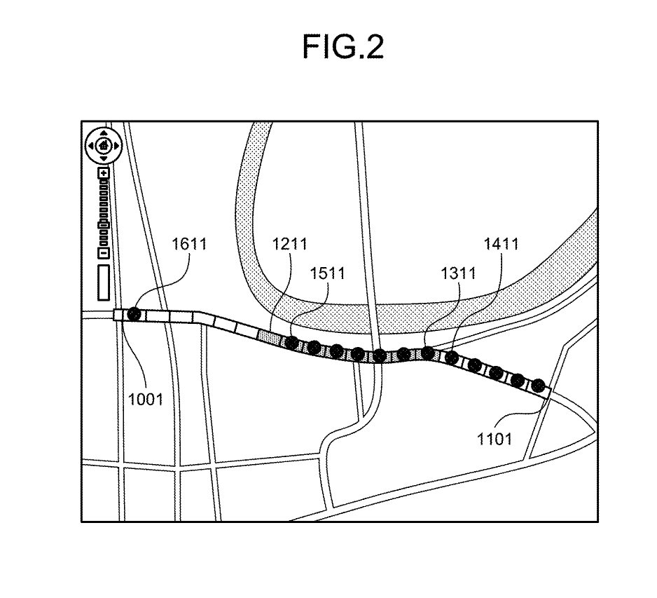

FIG. 1 indicates an example of the detection result obtained when, in the related technology, the degradation of the road surface is measured by using a measurement sensitivity lower than another measurement sensitivity, which will be described later, that is used in FIG. 2. If a low measurement sensitivity is used, for example, only the irregularities of the road surface in which measured acceleration is greater than a predetermined value are detected as the degradation of the road surface, whereas, if the measured acceleration is smaller than the predetermined value, the subject road surface is not detected as the degradation of the road surface even if irregularities of the road surface is generated.

In FIG. 1, for example, a mark “black diamond (♦)” attached to each of the section 1311 and a section 1411 indicates the section in which the degradation of the road surface is detected with a low measurement sensitivity. In contrast, for example, regarding the sections in each of which the degradation of the road surface is not detected with the low measurement sensitivity, the mark “black diamond (♦)” is not attached, as indicated by the section 1211, a section 1511, and a section 1611. However, even in the sections to which the mark “black diamond (♦)” is not attached, there may be a case in which small irregularities of the road surface that are not detected as the degradation of the road surface with a low measurement sensitivity are generated.

For example, in the section that is determined as cracked as indicated by the section 1511, even if small irregularities of the road surface that are not detected as the degradation of the road surface with a low measurement sensitivity are generated, an immediate restoration is preferable. However, in the related technology, if a low measurement sensitivity is used, the mark “black diamond (♦)” is not displayed when the degradation of the road surface is not detected irrespective of whether it is determined as cracked. In this case, for example, in the sections from the section 1211 to the section 1311 that are determined as cracked, a user may possibly overlook the section in which an immediate restoration is preferable. Namely, in the example illustrated in FIG. 1, there is a high possibility of an oversight in a change in the degree of degradation of the road surface.

In the following, an example of the detection result obtained when, in the related technology, the degradation of the road surface is measured by using a measurement sensitivity higher than the measurement sensitivity used in FIG. 1 will be described. FIG. 2 is a diagram illustrating another example of a detection result display screen of the road surface condition in the related technology. In FIG. 2, for example, a mark “black small circle (•)” attached to the section 1611 indicates the section in which the degradation of the road surface is detected with a high measurement sensitivity.

As illustrated in FIG. 2, if the degradation of the road surface is measured by using a high measurement sensitivity, in addition to the section 1311 to which the mark “black diamond (♦)” illustrated in FIG. 1 is attached, for example, the mark “black small circle (•)” is also displayed on the section 1511. Consequently, the user who has referred to the output result can recognize that the section 1511 is also the section in which an immediate restoration is preferable.

In contrast, for example, as indicated by the section 1611, also regarding the section that is not determined as cracked and in which the degradation of the road surface is not detected with a low measurement sensitivity and an immediate restoration is not important, similarly to the section 1511, the mark “black small circle (•)” is displayed. Consequently, the user who has referred to the output result may possibly, by mistake, recognize that the section 1611 is also the section in which an immediate restoration is preferable. Namely in the example illustrated in FIG. 2, there is a high possibility that noise is generated in detecting a change in the degree of degradation of the road surface.

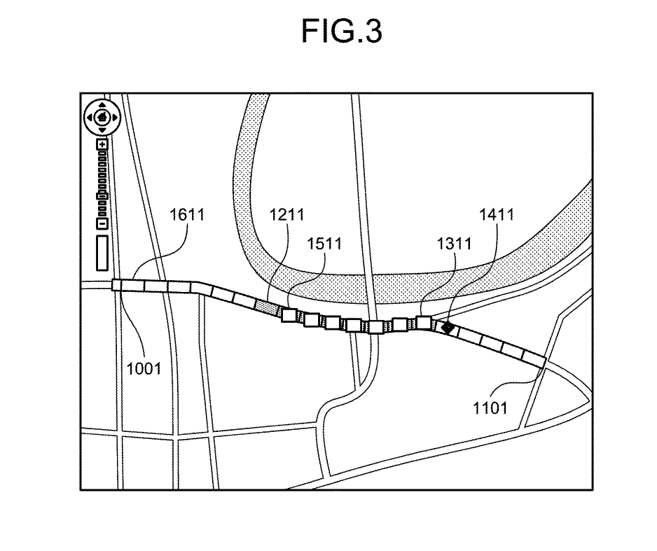

In the following, an example of the detection result according to the embodiment will be described. FIG. 3 is a diagram illustrating an example of the detection result display screen of the road surface condition according to the first embodiment. In FIG. 3, for example, a mark “outline square (□)” attached to the section 1511 indicates the section, in the sections that are determined as cracked, in which the degradation of the road surface is detected with a high measurement sensitivity. Furthermore, similarly to FIG. 1, also regarding the section that is not determined as cracked, for example, as indicated by the section 1411, regarding the section in which the degradation of the road surface is detected with a low measurement sensitivity, the mark “black diamond (♦)” is attached. In contrast, in FIG. 3, also regarding the section that is determined as cracked, if the degradation of the road surface is not detected with a high measurement sensitivity, neither the marks are attached, as indicated by the section 1211.

In the example illustrated in FIG. 3, the mark “outline square (□)” is attached to the section 1511 that is determined as cracked and in which the degradation is detected with a high measurement sensitivity but the degradation is not detected with a low measurement sensitivity. In contrast, in the example illustrated in FIG. 3, no mark is attached to the section 1611 that is not determined as cracked and in which the degradation is detected with a high measurement sensitivity. Consequently, a user can easily distinguish between the section in which an immediate restoration is preferable and other sections by viewing the detection result according to the embodiment.

In this way, the road surface condition detection device according to the embodiment increases, at a portion in which a crack is detected, the measurement sensitivity of the degradation of the road surface based on acceleration that indicates irregularities of the road surface, thereby allowing a user to easily identify whether an immediate restoration of the section is preferable.

Functional Block

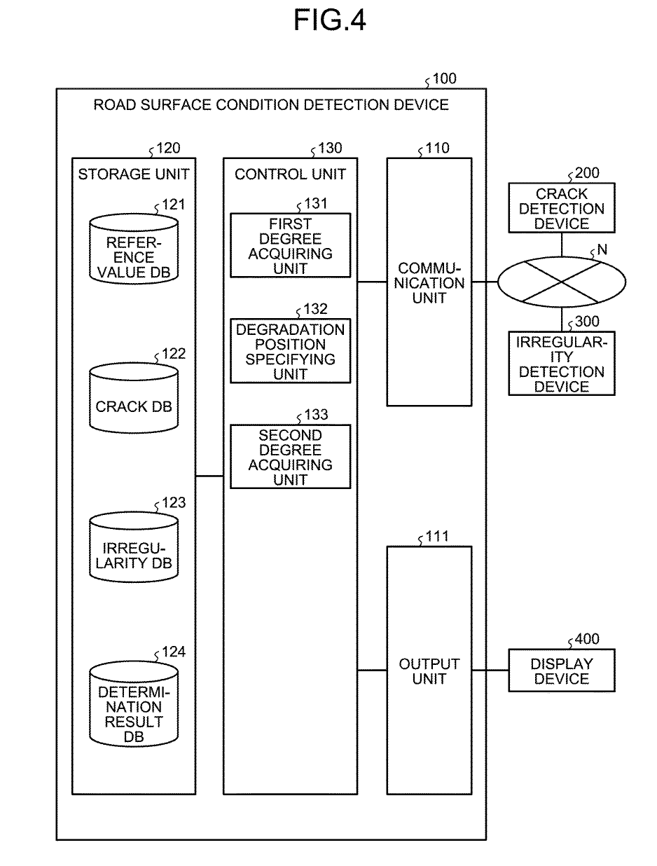

In the following, the functional configuration in the embodiment will be described. FIG. 4 is a diagram illustrating an example of the functional block of a road surface condition detection device according to the first embodiment. As illustrated in FIG. 4, a road surface condition detection device 100 according to the embodiment is connected to a crack detection device 200 and an irregularity detection device 300 via a network N so as to be communicated with each other. Furthermore, the road surface condition detection device 100 according to the embodiment is connected to a display device 400. Furthermore, the number of each of the road surface condition detection devices 100, the crack detection devices 200, the irregularity detection devices 300, and the display devices 400 according to the embodiment is not limited to the number of devices illustrated in the drawing.

The crack detection device 200 illustrated in FIG. 4 is a device that specifies a crack rate of the road surface by capturing and analyzing an image of the road surface. The crack detection device 200 specifies a crack rate of the road surface by analyzing the image of the road surface by using a known image analysis technology, or the like. The crack detection device 200 outputs information related to, for example, the crack rate of the road surface based on the request obtained by the road surface condition detection device 100. The crack detection device 200 is implemented by a computer having, for example, an image capturing function and is mounted on a mobile unit, such as a known automobile, or the like, that runs on the road surface; however, the example is not limited to this. Furthermore, the information related to the crack rate is an example of first degree of degradation.

The irregularity detection device 300 illustrated in FIG. 4 is a device that measures, by using the acceleration sensor, the magnitude of irregularities of the road surface based on the information indicating the flatness of the road surface. The irregularity detection device 300 detects high acceleration as, for example, the magnitude of the irregularities of the road surface is increased. The irregularity detection device 300 calculates the average value of the acceleration detected in, for example, the section of 100 m and outputs the value on the basis of the request from the road surface condition detection device 100. The irregularity detection device 300 is implemented by a mobile terminal, such as a smart phone, including, for example, an acceleration sensor and is mounted on a mobile unit, such as a known automobile, or the like, running on a road surface; however, the irregularity detection device 300 is not limited to this.

The display device 400 illustrated in FIG. 4 is a device that displays the information output from the road surface condition detection device 100. The display device 400 is implemented by, for example, an output device, such as a liquid crystal display, or the like.

In the following, a functional block of the road surface condition detection device 100 illustrated in FIG. 4 will be described. As illustrated in FIG. 4, the road surface condition detection device 100 includes a communication unit 110, an output unit 111, a storage 120, and a control unit 130. Furthermore, the road surface condition detection device 100 is implemented by a device, such as a computer, or the like and may also include, in addition to the functioning units illustrated in FIG. 4, various kinds of functioning units, such as an input device, an audio output device, or the like, included in a known computer.

The communication unit 110 controls communication between the crack detection device 200 and the irregularity detection device 300 via the network N irrespective of a wired or wireless manner. The output unit 111 displays the information output from the control unit 130 on the display device 400.

The storage 120 stores therein program executed by, for example, the control unit 130, various kinds of data, or the like. Furthermore, the storage 120 includes a reference value DB 121, a crack DB 122, an irregularity DB 123, and a determination result DB 124. The storage 120 corresponds to a semiconductor memory device, such as a random access memory (RAM), a read only memory (ROM), a flash memory, or the like or a storage device, such as a hard disk drive (HDD), or the like.

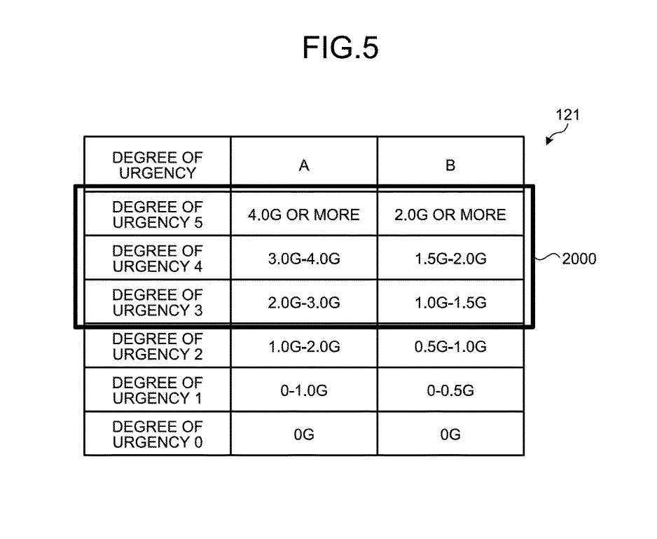

The reference value DB 121 stores therein, in an associated manner, acceleration indicating irregularities of the road surface and the degree of urgency for an immediate restoration of the road surface. FIG. 5 is a diagram illustrating an example of the reference value DB according to the first embodiment. As illustrated in FIG. 5, the reference value DB 121 stores therein, in an associated manner, the reference values “A” and “B” and the “degree of urgency”. Furthermore, the information stored in the reference value DB 121 is previously input by, for example, a user or an administrator of the road surface condition detection device 100. Furthermore, the reference value “A” is an example of a first measurement sensitivity used before measurement sensitivity is increased and the reference value “B” is an example of a second measurement sensitivity used after the measurement sensitivity is increased.

The “degree of urgency” illustrated in FIG. 5 indicates that an immediate restoration of the road surface is preferable as the number is increased. Furthermore, the embodiment will describe an example of determining that the sections determined to be equal to or greater than the “degree of urgency 3” indicated by a reference numeral 2000 are the “sections to be checked” indicating that a restoration of the road surface is preferable. Furthermore, the “degree of urgency” is an example of second degree of degradation.

In FIG. 5, “A” indicates the reference that is used to specify the degree of urgency from acceleration on the road surface that is not determined as cracked. Furthermore, in FIG. 5, “B” indicates the reference that is used to specify the degree of urgency from acceleration on the road surface that is determined as cracked. Furthermore, in FIG. 5, “x-y” in the column of “A” and the column of “B” indicates that the acceleration exceeds “xG” and is equal to or less than “yG”. For example, “0-0.5 G” indicates that the acceleration is “greater than 0 G and equal to or less than 0.5 G”.

As illustrated in FIG. 5, in both “A” and “B”, the lower limit of the “degree of urgency 1” is “0 G”. However, the upper limit of the “degree of urgency 1” is “1.0 G” in “A”, but is “0.5 G” in “B”. Similarly, in “B”, the upper limit and the lower limit of the “degree of urgency 2” to the “degree of urgency 4” are set lower than the upper limit and the lower limit of each of the pieces of the degree of urgency in “A”.

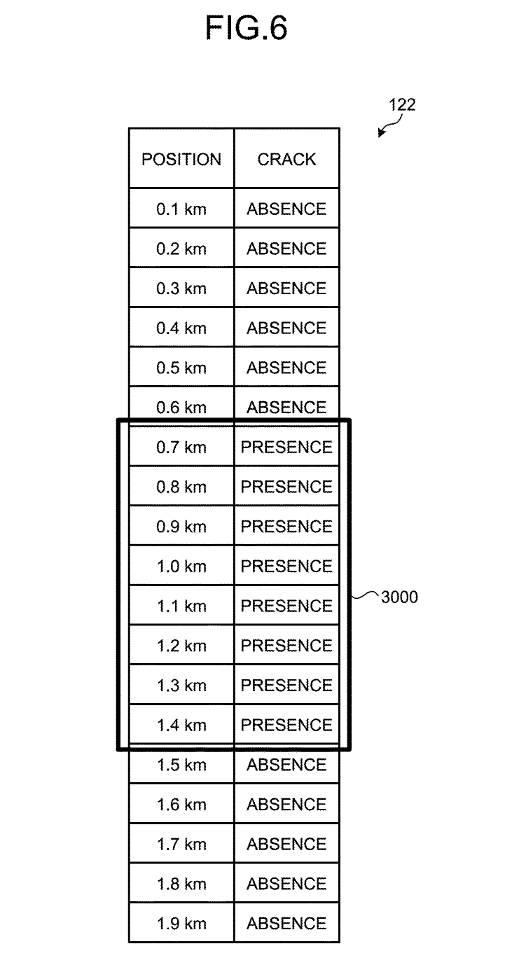

Then, the crack DB 122 stores therein, in an associated manner, the information based on a crack rate and the information related to a position that indicates a section of the road surface. FIG. 6 is a diagram illustrating an example of the crack DB according to the first embodiment. As illustrated in FIG. 6, the crack DB 122 stores therein, in an associated manner, the “position” and the “crack”. Furthermore, the information stored in the crack DB 122 is input by, for example, a first degree acquiring unit 131, which will be described later.

In FIG. 6, “presence” of a crack indicates, for example, that the crack rate acquired by the first degree acquiring unit 131 is equal to or greater than a predetermined threshold, whereas “absence” of a crack indicates that the acquired crack rate is less than a predetermined threshold. Thus, there may be a case in which, also regarding the section in which a crack is actually detected, “absence” of a crack is stored in the crack DB 122. Furthermore, the predetermined threshold is an example of a predetermined value.

For example, as indicated by a reference numeral 3000 illustrated in FIG. 6, because, in the portion from the section starting from the position of “0.7 km” to the section starting the position of “1.4 km”, the crack rate is equal to or greater than the predetermined threshold, the crack DB 122 stores therein information indicating that it is determined as cracked. Furthermore, as illustrated in FIG. 6, because, in the sections starting from the other positions, the crack rate is less than the predetermined threshold, the crack DB 122 stores therein information indicating that it is not determined as cracked.

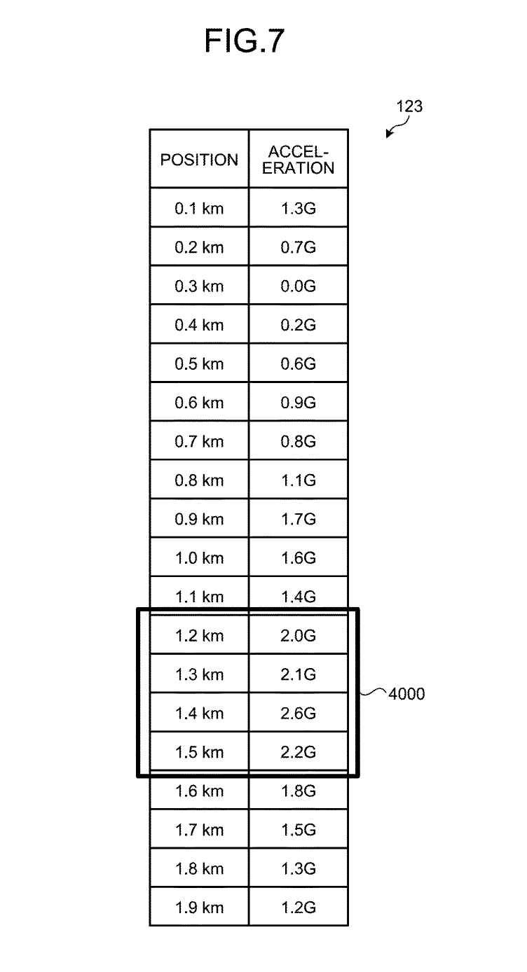

Then, the irregularity DB 123 stores therein, in an associated manner, the acceleration indicating the magnitude of irregularities of the road surface in each section and information related to a position indicating a section of the road surface. FIG. 7 is a diagram illustrating an example of the irregularity DB according to the first embodiment. As illustrated in FIG. 7, the irregularity DB 123 stores therein, in an associated manner, the “position” and the “acceleration”. Furthermore, the information stored in the irregularity DB 123 is input by, for example, a second degree acquiring unit 133, which will be described later.

For example, as indicated by a reference numeral 4000 illustrated in FIG. 7, the irregularity DB 123 stores therein information indicating that, in the portion from the section starting from the position of “1.2 km” to the section starting from the position of “1.5 km”, the acceleration is equal to or greater than “2.0 G”.

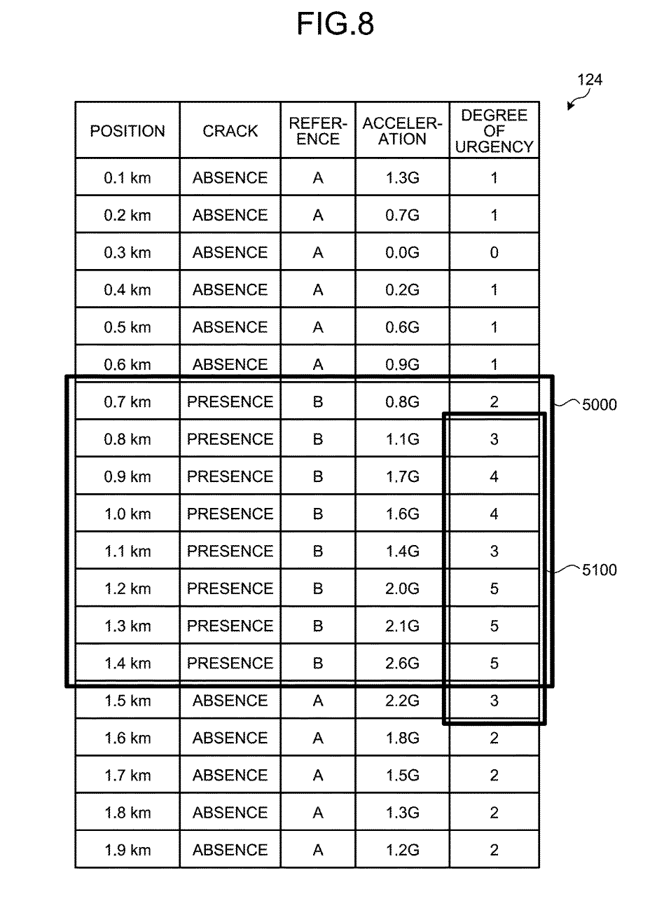

Then, the determination result DB 124 stores therein the information related to a crack in each section, the degree of urgency determined based on the information related to the flatness in each section, and the information related to an intermediate step specified in order to determine the degree of urgency. FIG. 8 is a diagram illustrating an example of the determination result DB according to the first embodiment. As illustrated in FIG. 8, the determination result DB 124 stores therein, in an associated manner, the “position”, the “crack”, the “reference”, the “acceleration”, and the “degree of urgency”. Furthermore, the information stored in the determination result DB 124 is input by, for example, a degradation position specifying unit 132 and the second degree acquiring unit 133, which will be described later.

In FIG. 8, the “crack” stores therein the information related to presence or absence of the crack stored in the crack DB 122. Furthermore, in FIG. 8, the “acceleration” stores therein the information related to the magnitude of the acceleration stored in the irregularity DB 123 as the information related to the flatness.

In FIG. 8, the “reference” stores therein the reference that is used to determine the degree of urgency. As illustrated in FIG. 8, the determination result DB 124 stores therein, for example, “A” related to the section indicated by “absence” of a “crack” and “B” related to the section indicated by “presence” of a “crack”.

In FIG. 8, the “degree of urgency” stores therein the degree of urgency specified based on the “reference” and the “acceleration”. For example, the determination result DB 124 stores therein, regarding the degree of urgency indicated by a reference numeral 5000, the degree of urgency specified by the reference value “B” illustrated in FIG. 5. Furthermore, a reference numeral 5100 indicates the section in which the degree of urgency is equal to or greater than “3” irrespective of whether the reference value is “A” or “B”.

Back to FIG. 4, the control unit 130 is a processing unit that manages an overall process performed by the road surface condition detection device 100 and is for example, a processor, or the like. The control unit 130 includes the first degree acquiring unit 131, the degradation position specifying unit 132, and the second degree acquiring unit 133. Furthermore, the first degree acquiring unit 131, the degradation position specifying unit 132, and the second degree acquiring unit 133 are an example of an electronic circuit included in a processor or an example of a process executed by a processor.

The first degree acquiring unit 131 acquires the information related to the crack rate. Specifically, if the first degree acquiring unit 131 receives the information related to the crack rate from the crack detection device 200 via the communication unit 110, the first degree acquiring unit 131 stores, in the crack DB 122, the received information in association with the position. The first degree acquiring unit 131 stores, in the crack DB 122, the information related to “presence” or “absence” of the crack illustrated in, for example, FIG. 6.

The degradation position specifying unit 132 specifies, by using the information related to presence or absence of the crack, the position in which the road surface is degraded. Specifically, the degradation position specifying unit 132 acquires the information related to presence or absence of the crack at each position from the crack DB 122. Then, the degradation position specifying unit 132 sets the reference value “A” regarding the position that is not determined as cracked and sets the reference value “B” regarding the position that is determined as cracked. Then, the degradation position specifying unit 132 stores the set reference value in the determination result DB 124.

The second degree acquiring unit 133 acquires the information related to the magnitude of irregularities of the road surface and specifies the degree of urgency. Specifically, if the second degree acquiring unit 133 receives the information related to the acceleration indicating the magnitude of irregularities of the road surface from the irregularity detection device 300 via the communication unit 110, the second degree acquiring unit 133 stores, in the irregularity DB 123, the received information in association with the position in which the acceleration is detected.

Furthermore, the second degree acquiring unit 133 sets, based on the information indicating whether the section is the degradation section, the measurement sensitivity that is used when the second degree of degradation is acquired. Specifically, the second degree acquiring unit 133 reads the reference value associated with the reference stored in the determination result DB 124 from the reference value DB 121. Then, the second degree acquiring unit 133 specifies, by using the read reference value, the degree of urgency from the information related to the acceleration stored in the irregularity DB 123.

For example, a process in which the second degree acquiring unit 133 specifies the degree of urgency about the section starting from the position of “0.8 km” will be described. First, the second degree acquiring unit 133 refers to the determination result DB 124 and sets “B” as the measurement sensitivity. Then, because the acceleration “1.1 G” stored in the irregularity DB 123 is included in “1.0 G-1.5 G” in “B” stored in the reference value DB 121, the second degree acquiring unit 133 specifies that the degree of urgency stored in the irregularity DB 123 is the “degree of urgency 3”.

Furthermore, if the second degree acquiring unit 133 specifies the degree of urgency related to the section starting from the position of “0.6 km”, the second degree acquiring unit 133 refers to the determination result DB 124 and sets “A” as the measurement sensitivity. Then, because the acceleration “0.9 G” stored in the irregularity DB 123 is included in “0 G-1.0 G” in “A” stored in the reference value DB 121, the second degree acquiring unit 133 specifies that the degree of urgency is the “degree of urgency 1”.

Flow of a Process

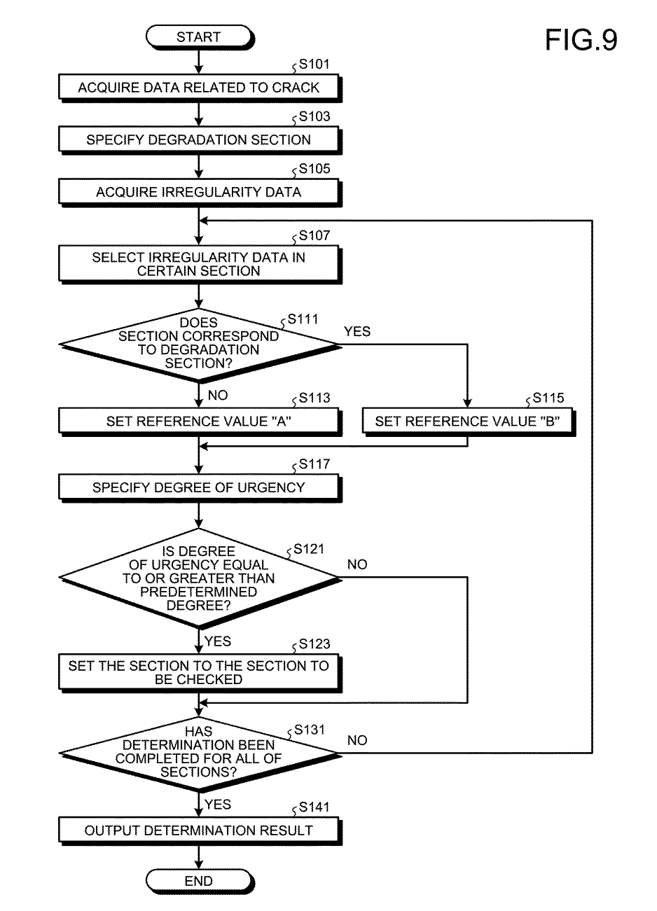

FIG. 9 is a flowchart illustrating an example of a road surface condition detection process. The road surface condition detection device 100 starts the road surface condition detection process by receiving, for example, a data acquisition request from a user.

As illustrated in FIG. 9, the first degree acquiring unit 131 in the road surface condition detection device 100 acquires the data related to the crack rate from the crack detection device 200 via the communication unit 110 (Step S101). Then, the first degree acquiring unit 131 stores the information related to presence or absence of the crack in the crack DB 122. Subsequently, the degradation position specifying unit 132 specifies the degradation section based on the stored data related to presence or absence of the crack (Step S103).

Then, the second degree acquiring unit 133 acquires, for example, acceleration as the irregularity data indicating the flatness of the road surface from the irregularity detection device 300 via the communication unit 110 (Step S105). Then, the second degree acquiring unit 133 selects irregularity data on the road surface of a certain section (Step S107).

Then, the second degree acquiring unit 133 determines whether the selected section corresponds to the degradation section (Step S111). If it is determined that the selected section does not correspond to the degradation section (No at Step S111), the second degree acquiring unit 133 sets the reference value “A” as the measurement sensitivity (Step S113). In contrast, if it is determined that the selected section corresponds to the degradation section (Yes at Step S111), the second degree acquiring unit 133 sets the reference value “B” as the measurement sensitivity (Step S115). Then, the second degree acquiring unit 133 specifies the degree of urgency by using the set reference value and the irregularity data (Step S117).

Then, the second degree acquiring unit 133 determines whether the degree of urgency specified in the subject section is equal to or greater than a predetermined degree (Step S121). If it is determined that the degree of urgency is equal to or greater than the predetermined degree (Yes at Step S121), the second degree acquiring unit 133 sets the subject section as the section to be checked (Step S123). In contrast, if it is not determined that the degree of urgency is equal to or greater than the predetermined degree (No at Step S121), the second degree acquiring unit 133 moves to Step S131.

Then, the second degree acquiring unit 133 determines whether the determination has been completed for all of the sections (Step S131). If it is determined that the determination has not been completed for all of the sections (No at Step S131), the second degree acquiring unit 133 returns to Step S107 and repeats the process. In contrast, if it is determined that the determination has been completed for all of the sections (Yes at Step S131), the second degree acquiring unit 133 allows the output unit 111 to output the determination result (Step S141).

For example, regarding the section 1511 illustrated in FIG. 6, because section 1511 corresponds to the degradation section at Step S111, the reference value “B” is set. Furthermore, at Step S117, the “degree of urgency 3” is specified. Furthermore, at Step S121, because it is determined that the “degree of urgency 3” exceeds the predetermined condition, the section 1511 is set as the section to be checked. By repeatedly performing the process on all of the sections illustrated in FIG. 6, the determination result as illustrated in, for example, FIG. 3 is output.

### Effects

In this way, because the road surface condition detection device 100 changes the measurement sensitivity in accordance with presence or absence of a crack, the road surface condition detection device 100 can reduce an oversight or noise generated at the detection of a progress of the degradation of the road surface.

### [b] Second Embodiment

The above explanation has described the first embodiment according to the present invention; however, the present invention may also be implemented with various kinds of embodiments other than the embodiments described above. For example, an embodiment may also be implemented by distinctively outputting information, regarding the position that is determined as cracked, indicating whether the degradation of a road surface can be detected even if a low measurement sensitivity is used, whether the degradation of a road surface can be detected as long as a high measurement sensitivity is used, or whether the degradation of a road surface is not detected even if the high measurement sensitivity is used.

For example, regarding the section that is determined as cracked and in which the degradation of the road surface is not detected with a low measurement sensitivity but can be detected with a high measurement sensitivity, it is conceivable that there is a high possibility that the degradation of the road surface deteriorates. If such a section can be distinguished, a user can designates the subject section as a section to be monitored more precisely, instead of a section to be checked, and can takes a countermeasures, such as an increase in measurement frequency of the section in which there is a high possibility that the degradation of the road surface deteriorates.

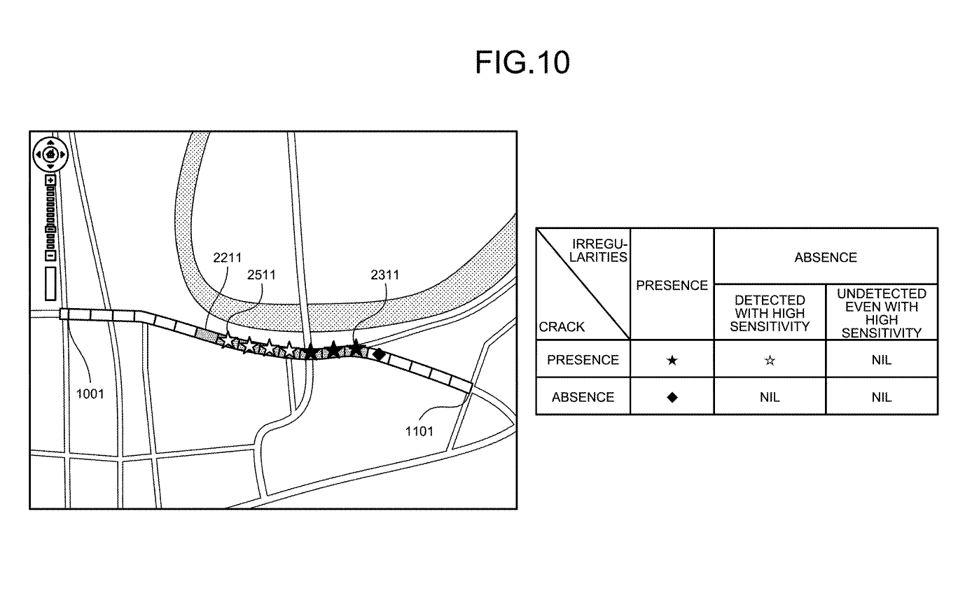

An example of the detection result according to the second embodiment will be described. FIG. 10 is a diagram illustrating an example of a detection result display screen of the road surface condition according to the second embodiment. In FIG. 10, as indicated by, for example, a section 2511, in the section that is determined as cracked, a mark “outline star ( [symbol] )” is attached to the section in which the degradation of the road surface is not detected with a low measurement sensitivity but is detected with a high measurement sensitivity. In contrast, even if the section that is similarly cracked, as indicated by, for example, a section 2311, a mark “black star ( [symbol] )” is attached to the section in which the degradation of the road surface is also detected with a low measurement sensitivity. Moreover, in FIG. 10, as indicated by, for example, a section 2211, in the section that is determined as cracked, none of the marks are attached to the section in which the degradation of the road surface is not detected even with high measurement sensitivity.

In this way, by changing the content to be output in accordance with the difference between the measurement sensitivities with which the degradation of the road surface is detected, it is possible to allow a user to precisely recognize the condition of the degradation of the road surface. However, the embodiment is not limited to this. For example, the embodiment may also be implemented so that the content to be output is changed in accordance with the magnitude of the detected degree of urgency, such as a case in which “at mark (@)” is used at the time of the “degree of urgency 4” and “cross mark (x)” is used at the time of the “degree of urgency 5”.

### [c] Third Embodiment

In each of the embodiments described above, an example has been described in which the degradation of the road surface is detected based on the magnitude of the measured acceleration; however, the embodiment is not limited to this. For example, it may also be possible to use the configuration in which two pieces of acceleration at different points of time are acquired and the degradation of the road surface is detected based on the rate of change of the acceleration.

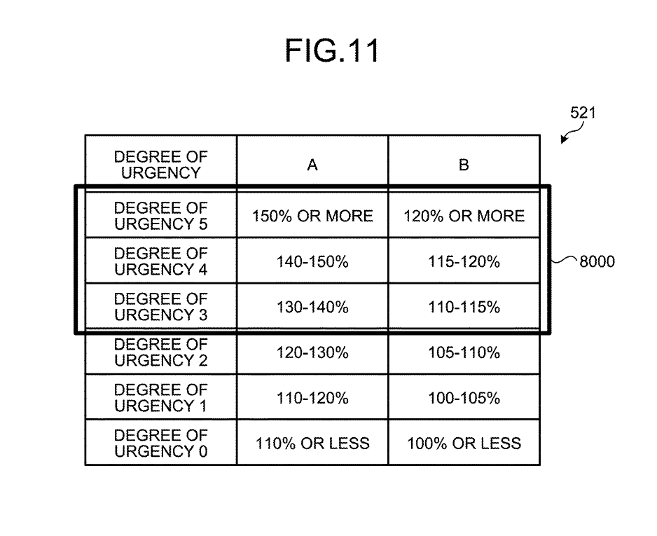

The third embodiment is different from the first embodiment because the range of the rate of change of the acceleration is used as a reference value. FIG. 11 is a diagram illustrating an example of a reference value DB according to the third embodiment. As illustrated in FIG. 11, a reference value DB 521 according to the third embodiment is the same as the reference value DB 121 according to the first embodiment because the “degree of urgency” and the reference values “A” and “B” are stored in an associated manner.

As illustrated in FIG. 11, in the third embodiment, the lower limit of the “degree of urgency 1” in “A” is “110%”, whereas the lower limit of the “degree of urgency 1” in “B” is “100%”. Namely, in the third embodiment, by decreasing the lower limit of the reference value, the measurement sensitivity of the degree of urgency is increased. Furthermore, the third embodiment describes an example in which the sections equal to or greater than the “degree of urgency 3” indicated by a reference numeral 8000 are determined to be “sections to be checked”.

In the following, the functional block of a road surface condition detection device 500 according to the third embodiment will be described. The road surface condition detection device 500 (not illustrated) includes, instead of the storage 120 and the control unit 130 illustrated in FIG. 4, a storage 520 and a control unit 530. The storage 520 includes the reference value DB 521, which will be described later, a crack DB 122 (not illustrated), the irregularity DB 123, and a determination result DB 524, which will be described later. Furthermore, the control unit 530 includes the first degree acquiring unit 131 and the degradation position specifying unit 132 and includes, instead of the second degree acquiring unit 133, a second degree acquiring unit 533.

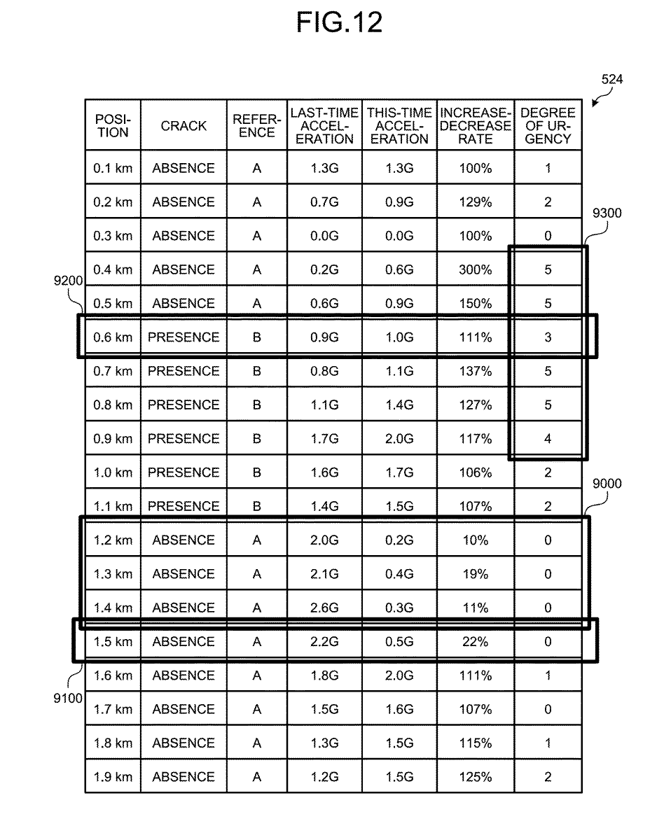

In the following, the determination result of the road surface condition according to the third embodiment will be described. FIG. 12 is a diagram illustrating an example of a determination result DB according to the third embodiment. As illustrated in FIG. 12, the determination result DB 524 according to the third embodiment is the same as the determination result DB 124 according to the first embodiment because the determination result DB 524 stores therein the “position”, the “crack”, the “reference”, and the “degree of urgency”. However, the determination result DB 524 according to the third embodiment differs from the determination result DB 124 according to the first embodiment because the determination result DB 524 stores therein, in an associated manner, “last-time acceleration”, “this-time acceleration”, and “increase-decrease rate”.

In FIG. 12, the “last-time acceleration” indicates the acceleration acquired before a predetermined point of time, whereas the “this-time acceleration” indicates the acceleration acquired after the predetermined point of time. Furthermore, the “increase-decrease rate” indicates an amount of increase or decrease in the “this-time acceleration” compared with the “last-time acceleration”. Furthermore, in the third embodiment, the “last-time acceleration” stores therein the “acceleration” described in the first embodiment illustrated in FIG. 8 and “this time acceleration” stores therein the newly acquired acceleration.

For example, the respective sections indicated by reference numerals 9000 and 9100 are the sections that are specified to be equal to or greater than the section “degree of urgency 3” by the determination result of the road surface condition illustrated in FIG. 8. In FIG. 12, the road surface is repaired in the subject sections and the acceleration indicating irregularities of the road surface is decreased. Furthermore, in the sections indicated by the reference numeral 9000, the crack of the road surface has been dissolved. In such a case, in the section indicated by, for example, the reference numeral 9100, the second degree acquiring unit 533 according to the third embodiment refers to the reference value DB 521 illustrated in FIG. 11 and specifies the “degree of urgency 0” by using the reference value “A” and the increase-decrease rate “22%”.

In contrast, as indicated by a reference numeral 9200, in the section starting from “0.6 km”, the acceleration is increased from the last-time acceleration “0.9 G” to “1.0 G” and a new crack is also generated. In such a case, the second degree acquiring unit 533 refers to the reference value DB 521 illustrated in FIG. 11 and specifies the “degree of urgency 3” by using the reference value “B” and the increase-decrease rate “111%”. Similarly, in the third embodiment, in the sections indicated by a reference numeral 9300, the degree of urgency is specified to be equal to or greater than the “degree of urgency 3”.

The degree of urgency specified in this way, similarly to FIGS. 1 to 3, the mark indicating the degree of urgency is attached and is output. In this way, by detecting the degradation of the road surface in accordance with the rate of change of the acceleration and by outputting the detection result, it is possible to detect the degradation of the road surface based on the progress status of the degradation in a case in which, for example, irregularities of the road surface are rapidly increased even if acceleration itself is not increased. For example, because irregularities of a road surface can be detected at low cost compared with detection of a crack, it is possible to easily detect the progress status of the degradation by repeatedly performing the detection.

### [d] Fourth Embodiment

The above explanation has described the embodiments according to the present invention; however, the present invention may also be implemented with various kinds of embodiments other than the embodiments described above.

For example, the configuration has been described in which the information that is set based on the crack rate and that is related to presence or absence of a crack is used; however, the embodiment is not limited to this. For example, the degree of crack may also be set in stages in accordance with the crack rate acquired from the crack detection device 200. For example, it may also be possible to use the configuration in which, if the crack rate acquired by the first degree acquiring unit 131 is less than “5%”, “1” is stored in the crack DB 122 and, if the crack rate is greater than “20%”, “3” is stored in the crack DB 122. Furthermore, it may also be possible to use the configuration in which the crack rate acquired by the first degree acquiring unit 131 is stored in the crack DB 122 without changing anything. By implementing the configuration in this way, it is possible to more precisely set the measurement sensitivity in accordance with the crack rate.

Furthermore, the configuration that uses, as the information related to the flatness, the acceleration detected in accordance with the irregularities of the road surface has been described; however, the embodiment is not limited to this. For example, it may also be possible to use the configuration in which the flatness of the road surface is specified by the irregularity detection device 300 detecting the magnitude of the irregularities of the road surface by using a laser, or the like. Furthermore, it may also be possible to use the configuration in which the second degree acquiring unit 133 receives an input of the flatness of the road surface that is visually determined.

Furthermore, the configuration that changes the range between upper limit and the lower limit of each of the pieces of the degree of urgency without changing the lower limit of the “degree of urgency 1” of the reference value illustrated in FIG. 5 has been described; however, the embodiment is not limited to this. For example, as illustrated in FIG. 11, it may also be possible to use the configuration that changes the lower limit of the “degree of urgency 1” or that changes both the lower limit and the range between the upper limit and the lower limit in each of the pieces of the degree of urgency.

Furthermore, it may also be possible to use the configuration in which the reference value DB 121 stores therein only a single reference value and, regarding the section in which a crack is detected, increases the region of the degree of urgency targeted for the section to be checked or processes the data on the acquired acceleration. For example, it may also be possible to use the configuration that, regarding the section that is not determined as cracked, the section equal to or greater than the “degree of urgency 3” is specified as the section to be checked, whereas, regarding the section that is determined as cracked, the section equal to or greater than the “degree of urgency 1” is specified as the section to be checked. Furthermore, the second degree acquiring unit 133 may also multiply a predetermined value by the acceleration data or add a predetermined value to the acceleration data or may also raise the acceleration data. In this way, by setting the reference value, it is possible to appropriately detect the degree of degradation of the road surface or the degree of progress of the degradation.

Furthermore, the configuration in which the first degree acquiring unit 131 in the road surface condition detection device 100 stores the information related to presence or absence of the crack of the road surface in the crack DB 122 has been described; however, the embodiment is not limited to this. For example, it may also be possible to use the configuration in which the information related to presence or absence of the crack that is acquired at different timing or that is determined by using a different method, such as a visual observation is previously stored in the crack DB 122.

Furthermore, the degrees of degradation used to acquire the first degree of degradation and the second degree of degradation are the degrees of degradation each having a different type, such as the degree of degradation, such as a crack, that is detected by image analysis and the degree of degradation, such as irregularities of the road surface, that is detected by using an acceleration sensor; however, the configuration is not limited to this. For example, it may also be possible to use the configuration in which another value, such as a rut amount, a value indicating the state inside the road surface that is detected by an ultrasonic sensor, the component or the pH value included in a pavement of the road surface, an inclination of the road surface, or the like, is also used in combination as the degree of degradation. In this way, by combining the different types of degrees of degradation, it is possible to reduce an overlook or noise generated at the detection of a progress of the degradation of the road surface.

System

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the crack DB 122 and the irregularity DB 123 may also be integrated or the second degree acquiring unit 133 may also be separated into a processing unit that acquires acceleration and a processing unit that specifies the second degree of degradation. Furthermore, all or any part of the processing functions performed by each device can be implemented by a CPU and by programs analyzed and executed by the CPU or implemented as hardware by wired logic.

Hardware Configuration

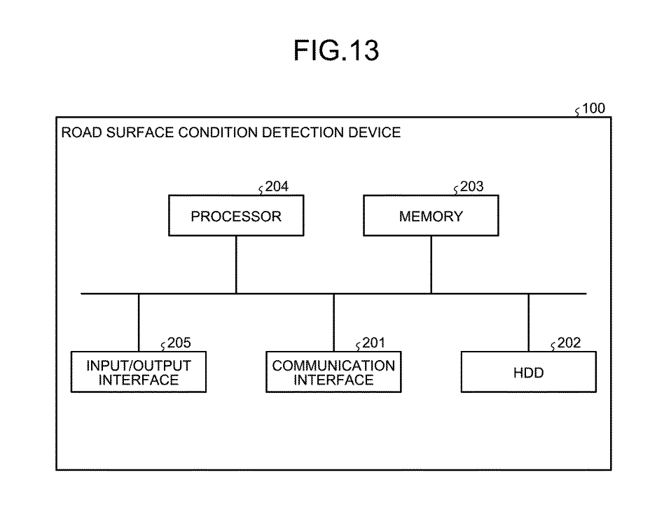

FIG. 13 is a diagram illustrating an example of the hardware configuration of the road surface condition detection device. As illustrated in FIG. 13, the road surface condition detection device 100 includes a communication interface 201, a hard disk drive (HDD) 202, a memory 203, a processor 204, and an input/output interface 205.

The communication interface 201 corresponds to the communication unit 110 indicated at the time of description of each of the functioning units and is, for example, a network interface card, or the like. The HDD 202 stores therein programs that operate the processing unit indicated at the time of description of each of the functioning units, databases, or the like.

By reading the programs that execute the same process that is performed by each of the processing units indicated at the time of description of each of the functioning units from the HDD 202, or the like and by loading the read programs in the memory 203, the processor 204 allows the process that executes each of the functions described with reference to FIG. 4, or the like. Namely, this process executes the same function that performed by the first degree acquiring unit 131, the degradation position specifying unit 132, the second degree acquiring unit 133 included in the road surface condition detection device 100. The input/output interface 205 corresponds to the output unit 111 indicated at the time of description of each of the functioning units.

In this way, by reading and executing the programs, the road surface condition detection device 100 is operated as an information processing apparatus that performs a road surface condition detection method. Furthermore, the road surface condition detection device 100 can also implement the same function described above in the embodiments by reading the programs described above from a recording medium by a medium reading device and executing the read programs described above. Furthermore, the programs described in the other embodiment are not limited to be executed by the road surface condition detection device 100. For example, the present invention may also be similarly used in a case in which another computer or a server executes the programs or in a case in which another computer and a server cooperatively execute the programs with each other.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a road surface condition detection program that causes a computer to execute a process comprising:
acquiring first degree of degradation for each position of a road;
specifying a degradation position in which the first degree of degradation indicates a degradation state lower than a predetermined value; and
increasing, when acquiring second degree of degradation for each position of the road by using a method different from a method used for the first degree of degradation, regarding the specified degradation position, a measurement sensitivity used at the time of acquiring the second degree of degradation.

2. The computer-readable recording medium according to claim 1, wherein
the increasing the measurement sensitivity includes
determining, regarding the degradation position, whether the second degree of degradation acquired by using a second measurement sensitivity that is used after the measurement sensitivity is increased matches a predetermined condition,
determining, regarding other positions of the road, whether the second degree of degradation acquired by using a first measurement sensitivity that is used before the measurement sensitivity is increased matches the predetermined condition, and
outputting information indicating a result of the determination at each position and information indicating the position of the degradation position.

3. The computer-readable recording medium according to claim 1, wherein the increasing the measurement sensitivity includes setting a lower limit of the measurement sensitivity low.

4. The computer-readable recording medium according to claim 2, wherein the increasing the measurement sensitivity includes setting the measurement sensitivity such that a range of values that matches the predetermined condition is small.

5. The computer-readable recording medium according to claim 2, wherein
the increasing the measurement sensitivity further includes
determining, at the specified degradation position, whether the second degree of degradation acquired by using the first measurement sensitivity matches the predetermined condition, and
outputting the information indicating the result of the determination at each position by distinguishing the degradation position in which the second degree of degradation acquired by the first measurement sensitivity matches the predetermined condition from the degradation position in which only the second degree of degradation acquired by using the second measurement sensitivity matches the predetermined condition and by superimposing the information onto the information indicating the position of the degradation position.

6. The computer-readable recording medium according to claim 1, wherein the increasing the measurement sensitivity includes comparing the second degree of degradation acquired at the degradation position before a predetermined point of time with the second degree of degradation acquired at the degradation position after the predetermined point of time.

7. The computer-readable recording medium according to claim 1, wherein the increasing the measurement sensitivity includes acquiring the second degree of degradation by using degree of degradation having a type that is different from a method of the first degree of degradation.

8. The computer-readable recording medium according to claim 7, wherein
the acquiring the first degree of degradation includes acquiring the degree of crack of a road surface at the position of the road, and
the increasing the measurement sensitivity includes acquiring, by using the degree of flatness of the road surface at the position of the road, the second degree of degradation as the degree of degradation having the type that is different from a method of the first degree of degradation.

9. A road surface condition detection device comprising:
a memory; and
a processor coupled to the memory, wherein the processor executes a process comprising:
acquiring first degree of degradation for each position of a road;
specifying a degradation position in which the first degree of degradation indicates a degradation state lower than a predetermined value; and
increasing, when acquiring second degree of degradation for each position of the road by using a method different from a method used for the first degree of degradation, regarding the specified degradation position, a measurement sensitivity used at the time of acquiring the second degree of degradation.
